(19) United States
(12) Patent Application Publication
(10) Pub. No.: US 2013/0068005 A1
(43) Pub. Date: Mar. 21, 2013

(54) TEST BENCH FOR A REACTION ENGINE

(71) Applicants: Noel David, Breuilpont (FR); Michel Fiolek, Conches-En-Ouche (FR); Jacques Lelong, Puiseux en Bray (FR); Nicolas Ravier, Vernon (FR); Romain Stephant, Aix-En-Provence (FR)

(72) Inventors: Noel David, Breuilpont (FR); Michel Fiolek, Conches-En-Ouche (FR); Jacques Lelong, Puiseux en Bray (FR); Nicolas Ravier, Vernon (FR); Romain Stephant, Aix-En-Provence (FR)

(73) Assignee: SNECMA, Paris (FR)

(21) Appl. No.: 13/580,671

(22) PCT Filed: Feb. 16, 2011
(86) PCT No.: PCT/FR11/50331

§ 371 Date: Dec. 6, 2012

(30) Foreign Application Priority Data
Feb. 24, 2010 (FR) 10/00744

(51) Int. Cl. G01M 15/02

(52) U.S. Cl. CPC G01M 15/02
USPC 73/116.03

(57) ABSTRACT

A test bench for a reaction engine including a nozzle having a divergent. The bench includes a mechanism for holding the divergent in position, capable of holding the divergent so that its axis is vertical, and capable of interacting with a downstream portion of the divergent located in the downstream half thereof to limit distortion and/or displacement of this downstream portion. The test bench enables the divergent to remain undamaged even if lateral forces are applied to it during testing.

The invention relates to a test bench for a reaction engine, and in particular for a rocket engine.

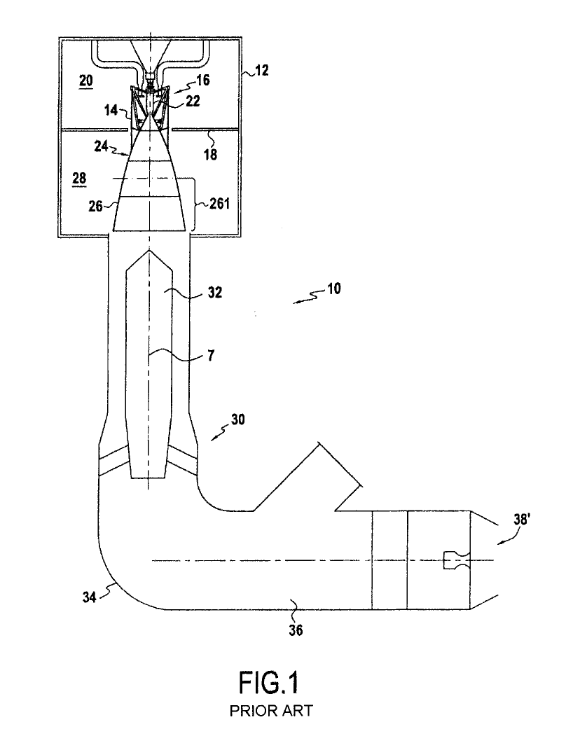

A test bench 10 of this type is presented in FIG. 1. It comprises an enclosure 12 equipped with means 14 for holding in position a reaction engine 16 subjected to testing, and in particular the divergent 26 of its nozzle 24. The enclosure 12 is separated into two parts by a horizontal floor 18. The upper part forms an engine chamber 20 wherein is located the body 22 of the engine 16 and a small portion of its nozzle 24.

In order that the engine 16 and its nozzle 24 be placed in a configuration similar to their normal operating conditions, they are positioned along a vertical axis; in addition, the nozzle 24 is attached to the engine as in normal operation.

The nozzle 24 consists of a small substantially cylindrical portion upstream continuing into the divergent 26, substantially conical and with a vertical axis Z. The divergent is that part of the nozzle located, in the normal gas flow direction, downstream of the smaller-diameter section of the nozzle. The larger portion of the divergent 26 is located in the lower chamber 28 located below the upper chamber 20, the chambers 20 and 28 constituting the enclosure 12.

During operating tests, the engine 16 enables combustion of the fuel and the oxidizer in a combustion chamber, not shown, and ejects the combustion gases via its nozzle 24. The combustion gases expand and accelerate during their passage in the divergent 26.

The engine 16 and its nozzle 24 in particular are positioned in the vertical direction in the chamber 12. The motor passes through an opening made in the floor 18.

Moreover, a large opening is made in the lower wall of the lower chamber 28. This opening allows passage for the end of the divergent 26 and for exhausting the combustion gases to a gas exhaust channel 30.

This channel 30 includes a first vertical portion located in line with the divergent 26 and wherein the gases ejected by the engine 16 are swallowed up during operational testing of the engine. These gases are first slowed down by a jet splitter 32 placed in the channel 30, which takes the form of a cylindrical element with an upstream conical point extension.

Downstream of the jet splitter 32, the channel forms a right angle elbow 34 beyond which it continues in a horizontal section 36.

Gas exhaust occurs at an exhaust opening 38 located downstream of the section 36.

The invention aims in particular to improve an altitude simulation test bench, such as the bench shown in FIG. 1. In this bench, the enclosure 12 which is designed to accommodate the body of the engine 16 is made sufficiently airtight to allow the establishment of a pressure lower than 200 mBar, or even 50 mBar, around the body of the engine 16 during testing.

This pressure that is lower than atmospheric pressure is created in a known manner within the enclosure 12 by the very combustion gas jet ejected by the engine 16, in conjunction with a system of suction pumps.

During engine testing on such test benchs, deterioration of the engines extending to bursting of the engines' nozzle, of their combustion chambers and of the means for holding the divergent in place were observable on engines subjected to operating tests.

The object of the invention is to propose a test bench for a reaction engine having a nozzle exhibiting a divergent, the bench comprising means for holding the divergent in position, capable of holding the divergent in such a way that its axis is vertical, a bench wherein the risk of damage to or destruction of the engine is reduced or even eliminated.

This object is attained thanks to the fact that said means are able to interact with a downstream portion of the divergent located in the downstream half thereof, in order to limit distortion and/or displacement of this downstream part. These means are intended to prevent distortions and/or displacement more particularly in a direction transverse to the axis Z of the divergent.

In certain embodiments the means for holding the divergent in position are able more precisely to interact with a portion of the divergent located in the third, or even the quarter of it that is farthest downstream.

Naturally, in addition to the means for holding the divergent in position capable of interacting with the downstream portion of the divergent located in the downstream half thereof, the bench can have other means for holding the divergent in position, capable for their part of interacting with the upstream portion of the divergent.

Indeed, during testing and particularly by analyzing the circumstances having led to damage to the engines under test, it appeared that this damage can occur at the very moment that testing stops, a very short time after shutting down fuel supply to the engine subjected to testing.

During testing, a stationary flow regime forms within the nozzle of the engine and the gas exhaust channel. This flow lowers the pressure in the divergent 26 and the chamber 12 to a very low value (typically on the order of 25 mBar), this depressurization of the enclosure 12 being brought about in known fashion by the ejection of combustion gases.

When fuel supply to the engine 16 is cut off, analysis has shown that pressure recovery occurs by way of a rising pressure or recompression wave propagating in a direction opposite the gas flow and going up the ejection channel 30 from its exit to the interior of the divergent 26.

Now it has been found in particular that even a slight asymmetry of the ejection channel, with respect to the divergent, leads to a pressure recovery within the divergent that is also asymmetrical. Inasmuch as it exhibits asymmetry, the recompression wave generates transverse forces applied to the divergent upon stopping the operating test of the engine 16. The hypothesis was then formulated that it is these transverse forces which are the cause of the damage to and destruction of engines mentioned previously, the downstream part of the divergent, due to its considerable surface area and to its distance from the body of the engine, being particularly susceptible to being damaged by the transverse forces exerted on the divergent.

Indeed, the usual means used to hold reaction engines subjected to testing are located on the upstream portion of the nozzle, and more precisely in an upstream portion occupying on the first upstream quarter of the divergent. These means can therefore not effectively hold the downstream portion of the divergent in the event of application of transverse forces thereon.

According to the invention, conversely, means for holding in position are placed in the test bench so as to be able to interact with the downstream portion of the divergent. They therefore contribute effective support to prevent distortion and/or displacement of the divergent upon stopping the test. It is therefore these means for holding in position which carry the major portion of the transverse forces generated by the recompression wave, rather than the structure of the engine itself, which is not sized to withbench them.

In one embodiment, said means for holding in position comprise an anti-ovalization structure, consisting of a ring for example, comprising portions arranged in a circle around the divergent and capable of coming into contact therewith to prevent its ovalization. Such a structure is defined here for a divergent with a circular cross-section, which is the general case; but its principle could be extended to divergents having a non-circular cross section. It is understood that such an anti-ovalization structure must be a rigid structure, capable of limiting the distortions of the divergent and of constraining it to retain a circular shape (at least at the points of contact between the divergent and the anti-ovalization structure).

The operation of the anti-ovalization structure is as follows: a first effect of the recompression wave is to non-circularly deform the downstream part of the divergent. In this embodiment, the holding means are designed to provide for maintaining the circularity of the divergent. If the divergent (on a line with the anti-ovalization structure) distorts so as to lose its circular shape, it comes into contact with the anti-ovalization structure which blocks or at least limits the distortion of the divergent and thus prevents or at least limits to an acceptable value the distortion of the divergent.

For this action to be effective, it is preferable that the anti-ovalization structure have a diameter nearly equal to the outer diameter of the divergent. Now during tests the divergent can be made to move in the plane perpendicular to its axis, either due to vibrations or due to thermal expansion, bringing about a displacement of the divergent in one direction or another.

To allow such displacements, in one embodiment said structure is free to move perpendicularly to the axis of the divergent within an interval, with respect to the fixed portion of the bench, such that this structure follows without snubbing them the low-amplitude transverse motions of the divergent during testing. It is understood here that the transverse motions are of low amplitude if they occur within the previously mentioned interval. This interval is limited by displacement- limiting means (stops, etc.).

The invention can advantageously benefit from the various improvements that follow, alone or in combination:

the means for holding in position can comprise at least one lateral displacement limiter, capable of limiting a lateral displacement of the divergent, that is in a direction perpendicular to the axis thereof;

said at least one lateral displacement limiter can be able to come into contact either directly with the divergent or with the anti-ovalization structure previously mentioned, to limit said lateral displacement of the divergent;

said at least one lateral displacement limiter can comprise a damping system for dissipating kinetic energy of lateral motion of the divergent, the damping system possibly including for example a friction element or a cylinder.

A second object of the invention is to propose an assembly comprising a test bench and an engine to be subjected to testing, said engine being a reaction engine having a nozzle having a divergent, an assembly wherein the risk of damage to or even destruction of the engine is reduced or eliminated. This object is attained thanks to the fact that the test bench conforms to the test bench previously presented.

In one embodiment of such an assembly, when the engine is stopped, the downstream half of the divergent is not in contact with said means for holding in position capable of interacting with a downstream portion of the divergent located in the downstream half thereof. Naturally, the divergent can also be held by other means for holding in position, but interacting only with the upstream half thereof.

The invention will be well understood and its advantages will be better revealed upon reading the detailed description that follows, of embodiments shown by way of non-limiting examples. The description makes reference to the appended drawings, wherein:

FIG. 1 is a schematic axial section view of a test bench according to a known embodiment;

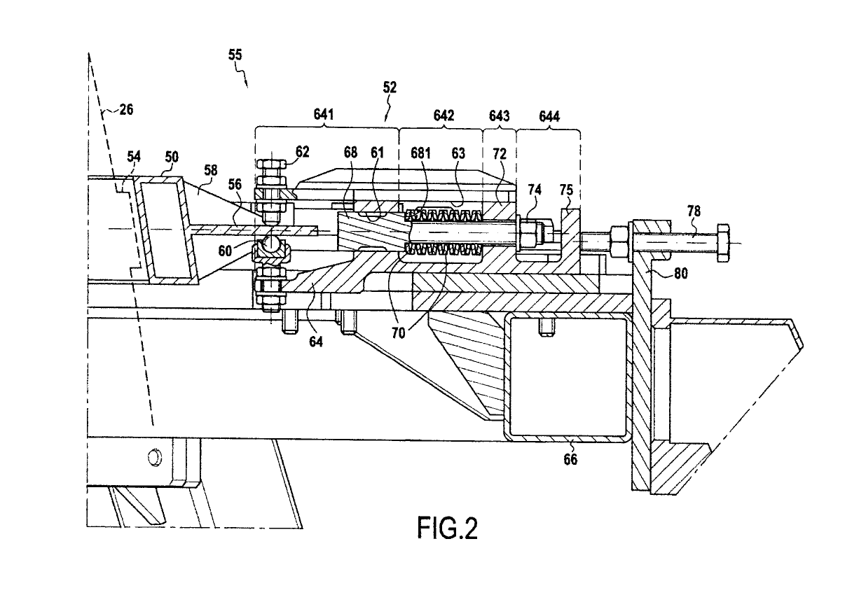

FIG. 2 is a section along a radial direction of the divergent of a test engine, of a test bench according to the invention;

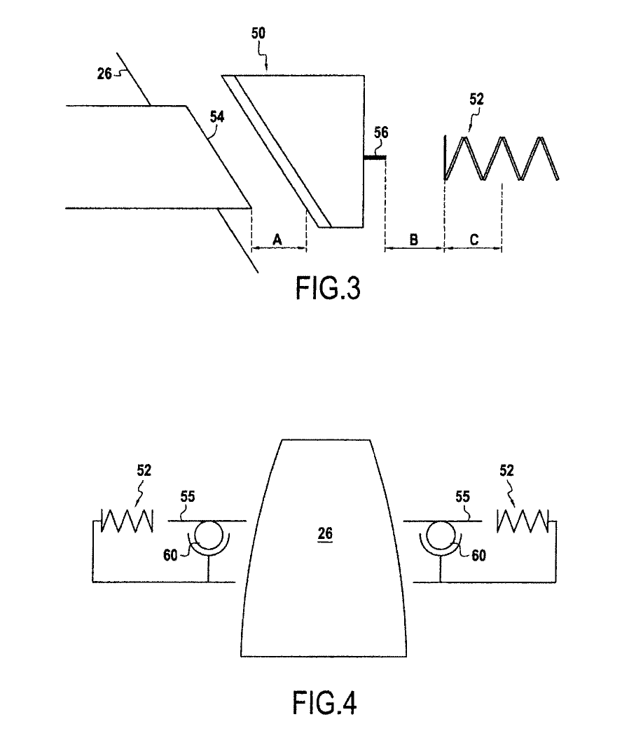

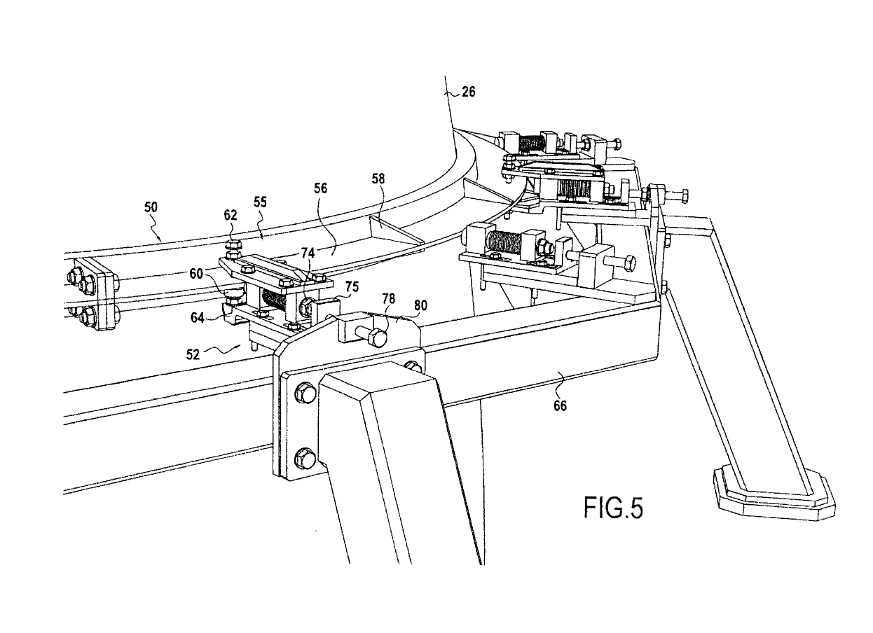

FIGS. 3 and 4 are schematic drawings illustrating the operation and the arrangement of the means for holding in position of the test bench of FIG. 2;

FIG. 5 is a schematic partial perspective representation of the test bench of FIG. 1;

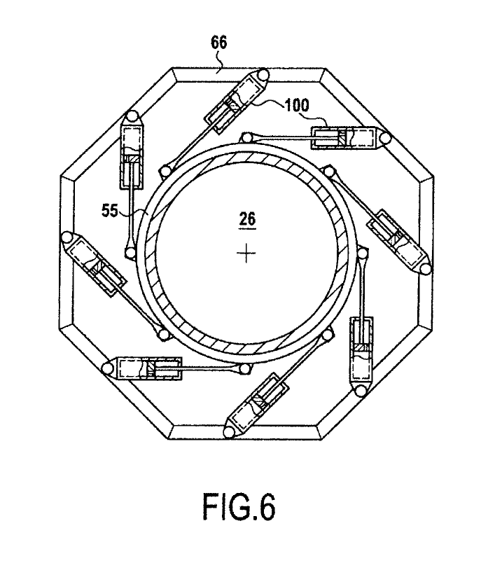

FIG. 6 is a section view, perpendicular to the axis of the divergent, of an engine test bench according to a second embodiment of the invention.

The invention can be implemented in a test bench such as that shown in FIG. 1. For this purpose, supplementary means must be provided for holding the divergent in position.

Such means are shown in FIGS. 2 and 5. These means mainly comprise a floating ring 50 with the same axis as the divergent 26, and displacement limiters 52 to limit the displacements of the ring 50 and hence of the divergent 26. The axis of the divergent being oriented in the vertical direction, transverse displacements of the divergent 26 are horizontal displacements.

The ring 50 has a generally circular shape. It exhibits a hollow cross-section, in which the wall located facing the divergent is parallel to the outer wall thereof. Preferably, the ring is set on a line with a reinforcing rib 54 of the divergent. Within the ring circulates a cooling liquid which is used to maintain the ring at an acceptable temperature with respect to its material.

The contact surfaces between the ring (as an anti-ovalization structure) and the divergent are substantially truncated, so as to fit the shape of the outer surface of the divergent.

On the radially outer wall of the ring is attached a stiffening rib 56. This is a piece of flat plate shaped like a large-sized washer and is used to prevent any distortion of the ring in the horizontal plane, which would allow the divergent to undergo non-circular distortion, and consequently the generation of stresses within its material. The rib 56 is attached to the ring 50 by a set of angle brackets 58, each being placed in a meridional plan with respect to the Z axis. The ring 50, the rib 56 and the brackets 58 thus constitute an anti-ovalization structure 55.

The ring 50 is held in position by the displacement limiters 52, which are used as both vertical and lateral displacement limiters. These limiters 52 have a regular angular distribution over the circumference of the rib 56 at the rate of one limiter every 10°.

The ring 50 is held at a height which allows it to interact with a downstream portion 261 of the divergent 26 located in the downstream half thereof and thus to limit a distortion and/or a displacement of this downstream portion of the divergent.

To support the ring 50 in the vertical direction, each of the displacement limiters 52 has a ball 60 placed below the rib 56. The rib 56, and with it the ring 50, are thus mechanically supported in the vertical direction by the full set of balls 60.

Furthermore, upward displacements of the rib 56 are contained by adjustable counter-screws 62 with which a portion of the displacement limiters are equipped (it is not necessary to equip all the limiters 52, due to the fact that the weight of the ring naturally tends to hold it against the balls 60).

The rib 56 and hence the floating ring 50 are therefore constrained to move only in a horizontal plane. The balls 60 are substantially free in rotation, which allows the ring 50 and the rib 56 to move freely, within certain limits, in a horizontal direction. The balls 60, as well as the counter-screws 62, are fixed directly or via intermediate parts onto the body 64 of the displacement limiters 52. These limiters 52 are in turn fixed on an arc-welded support structure 66 fixed inside the lower chamber 28 of the test bench.

On the other hand, horizontal displacements of the floating ring 50 are limited by the displacement limiters 52, in their role as lateral displacement limiters. Each of them comprises a stop 68 made of elastic material, set horizontally on a line with the rib 56.

The stop 68 has a generally cylindrical shape. It is mounted free to slide within the limiter 52 in the radial direction with respect to the divergent 26.

To allow for holding the stop 68, the displacement limiter 52 comprises four radially spaced parts.

In the first (radially inner) part 641, the body 64 provides (directly or not) for holding the ball 60 and the counter-screw (if any) 62. It also comprises a bore 61 wherein the stop 68 slides with a small clearance, and which makes it possible to guide the displacements thereof in a radial direction.

In the second part 642, the body 64 comprises a chamber 63 wherein the stop 68 passes without contact. The internal dimensions of this chamber allow a set of Belleville washers 70 to be arranged around the stop 68, in this chamber.

On the radially inward side of the aforementioned chamber, the stop 68 comprises a shoulder 681 which prevents inward displacements of the washers 70. In the third part 643, the stop 68 passes through a passage formed in a wall 72 perpendicular to the radial direction of the body 64, a passage which contributes to guiding the stop 68 during its radial displacements.

The fourth part 644 is located radially at the end of the stop 68 and is used to hold an outer stop 78 the operation whereof will be described later.

But before that, the operation of the stop 68 of the displacement limiter 52 should be specified.

The radially outer end of the stop 68 comprises an external thread whereon is threaded a nut 74. The washers 70 are compressed between the wall 72 and the shoulder 681 of the stop 68. Thus, in normal times, they tend to move the stop 68 inward, toward the axis of the divergent, until the nut 74 is put in contact with the wall 72.

Conversely, during engine tests, if the divergent 26 moves laterally (horizontally), in the direction that causes the rib 56 to come into contact with the stop 68, the rib 56 presses on the radially inner end of the stop and tends to move the stop outward, thus compressing the washers 70. The stop 68, and more generally the limiter 52, brakes and blocks the displacement of the ring 50 and of the divergent 26.

The Belleville washers 70 constitute a damping system, which stores part of the kinetic energy elastically but also dissipates part of it in interactions between the washers. Other damping systems can naturally be used while still remaining within the scope of the invention.

If the thrust of the divergent is particularly strong, the displacement of the stop 68 is limited by a second, outer stop (fixed stop) 78, which the stop 68 hits if the washers 70 were not able to contain its displacement. This fixed stop 78 has the form of a radial rod, which like the limiter 52 is rigidly fixed to the support structure 66, by means of a support 80. Its radial position is adjustable with respect to the support 80.

The radially outer part 644 of the body 64 of the limiter 52 comprises a vertical wall 75, having a passage through which passes the outer stop 78. This passage makes it possible to guide the outer stop 78 and to ensure that at the time when the stop 68 is pushed outward by the ring 50 and the rib 56 it actually comes into contact with the outer stop 78.

FIGS. 3 and 4 specify the mechanical behavior of the means for holding in position which were presented previously, to wit essentially the anti-ovalization structure 55 and the displacement limiters 52.

The divergent is mounted with a radial clearance A, which is preferably relatively small, within the anti-ovalization structure 55. This clearance allows in particular for variations in the size of the divergent during testing, due to thermal expansions/contractions.

The anti-ovalization structure 55 is mounted floating on balls 60, which means that it can move substantially freely, in the horizontal plane, within certain limits naturally. For this purpose, a clearance B is provided between the anti-ovalization structure and the displacement limiters 52. Thus, when (or in case) the divergent moves laterally during testing, due to differential thermal expansion, the anti-ovalization structure 55 moves with the divergent without generating mechanical forces within it. The displacement is naturally limited to the sum of the clearances A and B.

Finally, thanks to the use of limiters 52 equipped with damping systems (washers 70), the displacements of the divergent and of the anti-ovalization structure can be contained in a relatively elastic manner, this in order to avoid shocks and not to damage the divergent 26, or even the engine itself. The displacement limiters therefore allow a supplementary displacement C, in the radial direction, beyond which the displacement is positively stopped, by means of the outer stops 78 mentioned previously.

In practice, the clearances A, B and C have the values 12 mm, 15 mm and 5 mm respectively, for a divergent diameter on the order of 2 meters.

FIG. 6 shows another embodiment of the displacement limiters, wherein:

vertical displacements are contained by balls 60 and counter-screws 62 identical to what was previously presented (not shown); and

transverse displacements are contained by double-acting cylinders 100, in this case “Dashpot” type oil damping cylinders.

Each of these cylinders is then fixed at its radially outer end, to a fixed part of the test bench (in this example, the support structure 66), and at its radially inner end to the anti-ovalization structure 55 (either to the rib 56 or directly to the ring 50).

These cylinders can be arranged in the radial direction or, with substantially the same result, along transverse directions that are oblique with respect to the radial direction, as can be seen in FIG. 6. This latter arrangement advantageously enable a reduction in the total bulk of the means for holding in position of the divergent, hence of the test bench.

1-11. (canceled)

12. A test bench for a reaction engine having a nozzle having a divergent, the bench comprising:
means for holding the divergent in position capable of holding the divergent so that its axis is vertical,
wherein said means is further capable of interacting with a downstream portion of the divergent located in the downstream half thereof, to limit distortion and/or displacement of this downstream portion.

13. The test bench according to claim 12, wherein said means for holding in position comprises an anti-ovalization structure, comprising portions arranged in a circle around the divergent, or having a shape of a ring, and capable of coming into contact with the divergent to prevent an ovalization thereof.

14. The test bench according to claim 13, wherein the structure is free to move perpendicularly to the axis of the divergent, within an interval, with respect to a fixed portion of the bench, such that this structure follows small-amplitude displacements of the divergent during testing without snubbing them.

15. The test bench according to claim 13, wherein the anti-ovalization structure includes contact surfaces between the structure and the divergent having a substantially truncated shape, so as to fit a shape of an outer surface of the divergent.

16. The test bench according to claim 12, wherein the means for holding in position comprises at least one lateral displacement limiter capable of limiting a transverse displacement of the divergent.

17. The test bench according to claim 13, wherein the means for holding in position comprises at least one lateral displacement limiter capable of limiting a transverse displacement of the divergent, and wherein the at least one lateral displacement limiter is capable of coming into contact with the anti-ovalization structure so as to limit the lateral displacement of the divergent.

18. The test bench according to claim 16, wherein the at least one lateral displacement limiter comprises a damping system for dissipating kinetic energy of lateral displacement of the divergent, the damping system including a friction element or a cylinder.

19. The test bench according to claim 12, configured to allow establishment of a pressure below 200 mBar, or 50 mBar, around a body of an engine during testing.

20. The test bench according to claim 12, further comprising an enclosure capable of accommodating a body of the engine and made sufficiently airtight to allow establishment of a pressure below 200 mBar, or 50 mBar, around the body of the engine during testing.

21. An assembly comprising:
a test bench according to claim 12; and
an engine to be subjected to testing, the engine being a reaction motor having a nozzle having a divergent.

22. An assembly according to claim 21, wherein when the engine is stopped, the downstream half of the divergent is not in contact with the means for holding the divergent in position capable of interacting with a downstream portion of the divergent located in the downstream half thereof.
